(19) United States
(12) Patent Application Publication
(10) Pub. No.: US 2026/0201674 A1
(43) Pub. Date: Jul. 16, 2026

(54) PRESSURE FEEDBACK FOR ELECTRONIC JOYSTICK

(71) Applicant: Danfoss Power Solutions ApS, Nordborg (DK)

(72) Inventor: Abel Dukai, Sønderborg (DK)

(21) Appl. No.: 19/440,939

(22) Filed: Jan. 6, 2026

(30) Foreign Application Priority Data
Jan. 10, 2025 (EP) 25151265.3

(51) Int. Cl. E02F 9/20; E02F 3/30; E02F 3/42; E02F 9/22; G05G 9/047

(52) U.S. Cl. CPC E02F 9/2004; E02F 3/425; E02F 9/2203; G05G 9/047; E02F 3/308; G05G 2009/04755; G05G 2009/04766

(57) ABSTRACT

The invention relates to a control system for a hydraulic system for moving a tool. The control system comprises a joystick and an electronic controller. The joystick includes a joystick handle configured to be manipulated by an operator for indicating desired movements of the tool. The joystick includes joystick sensors for sensing movements of the joystick handle. The joystick is configured to provide the control signals to the electronic controller based on the movements of the joystick handle. In order to facilitate precise control for the operator, the electronic controller and the joystick are operable to provide feedback to the joystick handle should there be an increase in hydraulic pressure sensed in the hydraulic system related to the tool. An assembly including the control system and a method are also disclosed.

### CROSS-REFERENCE TO RELATED APPLICATIONS

This application claims priority to European Patent Application No. 25151265.3 filed on Jan. 10, 2025, which is incorporated by reference herein in its entirety.

### BACKGROUND

The invention relates to a control system for a hydraulic system for moving a tool, the control system comprising a joystick and an electronic controller. The invention further relates to an assembly including the control system and to a corresponding method.

Joysticks are known, and operate to control various tools. As an example, heavy construction equipment such as shovels may be controlled by joysticks.

Historically, joysticks would be manipulated by an operator to send hydraulic signals to a controller for the tool. More recently the joystick is manipulated to send electronic signals to a controller of desired movement of the tool. This then results in the controller sending hydraulic fluid to move the tool.

Particularly when used with construction equipment, the tool may encounter an obstacle. As one example, a shovel could inadvertently contact a pipe when digging in the ground.

When an obstacle would be contacted by a tool, and with a hydraulic joystick, there is a hydraulic pressure feedback to the joystick. This lets the operator know that there is the potential for having contacted an obstruction.

With an electronic joystick, no such feedback is provided.

Without feedback, the operator might not realize that the tool contacts the obstacle. This may result in damages of the tool and/or the obstacle.

### SUMMARY

The object underlying the invention is to facilitate precise control for the operator.

The control system is for a hydraulic system for moving a tool. The control system comprises a joystick and/or an electronic controller.

The joystick includes a joystick handle configured to be manipulated by an operator, e.g. for indicating (for inputting) desired movements of the tool. The joystick includes joystick sensors for sensing movements of the joystick handle. The joystick is configured for providing control signals to the electronic controller based on the movements of the joystick handle.

The control system is operable to provide feedback to the joystick handle should there be an increase in pressure sensed at the hydraulic system, especially related to the tool. Especially, the electronic controller and the joystick may be operable to provide feedback to the joystick handle should there be an increase in hydraulic pressure sensed at the hydraulic system, especially related to the tool. For example, the hydraulic pressure may be sensed at the tool.

According to one aspect, the electronic controller is configured for receiving measurement signals from a pressure sensor (at least one pressure sensor) for sensing the hydraulic pressure. The electronic controller can be configured to provide pressure feedback signals based on the measurement signals to the joystick.

The control system can include the pressure sensor, and optionally several pressure sensors. Each sensor may sense the hydraulic pressure related to an individual movement operation of the tool. The electronic controller may be connected to the pressure sensor(s).

The joystick can be configured to apply the (mechanical) feedback to the joystick handle based on the pressure feedback signals received from the electronic controller.

According to one aspect, the control signals can be indicative of the desired movements of the tool. The control signals may correspond to (and/or be based on) mechanical inputs applied by the operator via the joystick handle.

In another embodiment according to the previous embodiment, the joystick (further) includes a swashplate and a plurality of pushrods, wherein the joystick handle is configured to move the swashplate for in turn controlling movements of the (plurality of) push rods toward and away from the joystick sensors to sense movements of each of the (plurality of) push rods, and to create the control signals to the electronic controller thereupon.

In another embodiment according to any of the previous embodiments, the joystick includes, for each of the (plurality of) push rods, a respective spring for biasing the corresponding push rod towards the swashplate.

In another embodiment according to any of the previous embodiments, each of the (plurality of) push rods is surrounded by a corresponding solenoid, and wherein the electronic controller is configured to control each of the solenoids to provide a pushing magnetic force on the corresponding push rod (of the plurality of push rods) to urge it towards the swashplate. In particular, the electronic controller may be configured to control the solenoids via the pressure feedback signals to generate the (mechanical) feedback.

In another embodiment according to any of the previous embodiments, the joystick sensors are Hall effect sensors.

The problem indicated above is further solve by an assembly for operating a tool, wherein the assembly comprises: a hydraulic system having a hydraulic tool drive for moving the tool; and a the control system according to the invention. The embodiments and advantages described regarding the control system may also apply accordingly regarding the assembly, and vice versa.

The electronic controller is configured for controlling movement of the tool through the hydraulic tool drive. The electronic controller controls the supply of a hydraulic fluid to move the tool based upon the control signals from the joystick. A pressure sensor senses a hydraulic pressure at the hydraulic system, e.g. at the tool, as the tool is moved.

The hydraulic tool drive may be (configured to be) mechanically coupled to the tool. The tool may include (at least parts of) the hydraulic tool drive.

In one embodiment, the assembly is configured to: the electronic controller communicates with the joystick. The joystick is adapted to be manipulated (e.g. by an operator handling the joystick handle) and the joystick sensors are adapted for sending the control signals (e.g. based on the detected movements of the joystick handle) to the electronic controller to supply the hydraulic fluid to the tool drive for moving the tool. The electronic controller is operable to provide a pressure feedback signal to the joystick to provide a feedback force should the sensed pressure increase.

In another embodiment according to any of the previous embodiments, the tool is a shovel. Additionally or alternatively, the assembly is configured such that the hydraulic pressure increases in pressure if the tool (e.g. the shovel) encounters an obstruction. The assembly may include the tool (e.g. the shovel).

The problem indicated above is further solved by a method. The method may be for moving a tool by using a hydraulic system.

The method includes providing a tool and a control system for controlling movement(s) of the tool. The control system includes an electronic controller and a joystick connected to the electronic controller. The electronic controller controls supply of hydraulic fluid to a hydraulic tool drive to move the tool based upon the control signals from the joystick. Accordingly, the joystick may send the (electric) control signals to the electronic controller in order to supply hydraulic fluid to the hydraulic tool drive and to move the tool. A pressure sensor senses a hydraulic pressure at the hydraulic tool drive (e.g. at the tool) as the tool moves. The electronic controller provides a feedback signal to the joystick to provide a feedback force based upon the sensed hydraulic pressure.

The embodiments and advantages described regarding the control system and/or the assembly may apply according regarding the method, and vice versa.

According to one aspect, a joystick handle moves a swashplate to move a plurality of push rods toward and away from a joystick sensor unit sensing movement of each of the plurality of push rods, wherein the joystick sensor unit sends the (electric) control signals to the electronic controller.

The joystick sensor unit may comprise a plurality of joystick sensors, for example (at least) one joystick sensor (maybe exactly one joystick sensor) for each push rod.

The joystick sensor unit may include Hall effect sensors.

In another embodiment according to any of the previous embodiments, each of the push rods is pressed towards the swashplate by a respective biasing spring.

In another embodiment according to any of the previous embodiments, each of the (plurality of) push rods is provided with a corresponding solenoid, wherein the electronic controller controls at least one of the solenoids to provide magnetic force on the corresponding push rod (of the plurality of push rods) to urge it towards the swashplate based on an increase of the sensed hydraulic pressure.

In another embodiment according to any of the previous embodiments, the tool is a shovel and the hydraulic fluid increases in pressure as the shovel encounters an obstruction.

These and other features will be best understood from the following drawings and specification, the following is a brief description.

### BRIEF DESCRIPTION OF THE DRAWINGS

FIG. 1A schematically shows an operator and a construction vehicle.

FIG. 1B shows an existing joystick.

FIG. 2 shows an inventive electronic joystick.

FIG. 3A shows a system for operating the new joystick of FIG. 2.

FIG. 3B shows a control feature with the new joystick.

### DETAILED DESCRIPTION

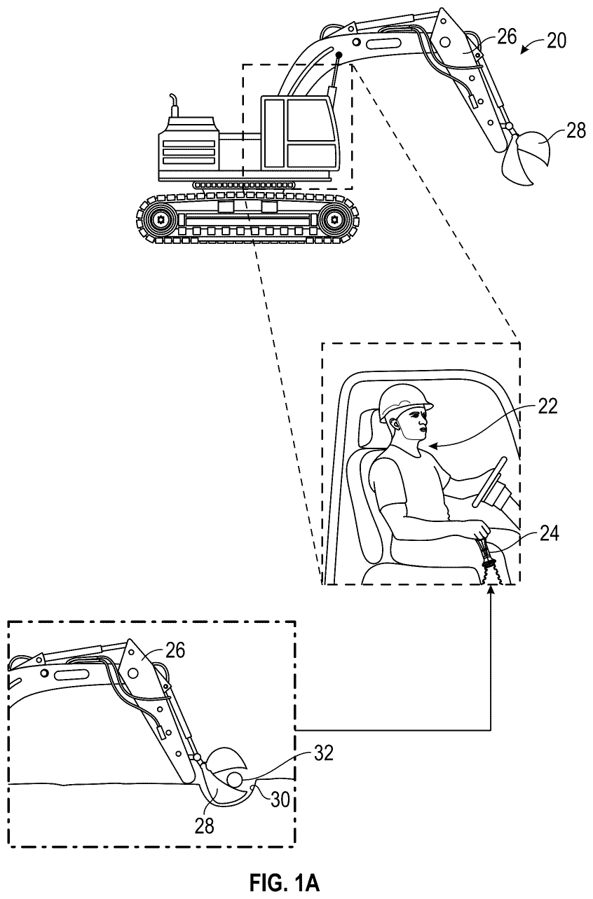

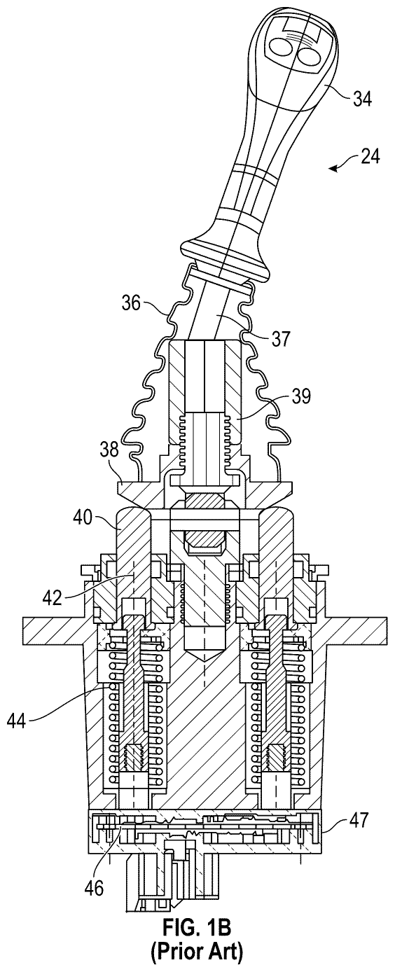

A vehicle 20 has an operator 22 manipulating a joystick 24 in FIG. 1A. As can be seen, the joystick 24 controls movement of an arm 26 and a shovel 28. The shovel 28 is shown digging a hole 30. It is possible when performing such an operation that the shovel 28 could encounter an obstruction, such as a pipe 32. As mentioned above, if the joystick 24 is an electronic joystick there would not be feedback that the obstruction is being contacted.

FIG. 1B shows details of the prior art swashplate joystick 24. An articulating link 37 is connected to handle 34. When the handle 34 is manipulated operator 22, the articulating link 37 moves a shaft 39. The joystick 24 may pivot about two axes both into and out of the plane of FIG. 1B and to the right and left in FIG. 1B.

As the joystick 34 is manipulated, the orientation of a swashplate 38 changes to selectively drive push rods 40 having a remote end 42 toward and away from Hall effect sensors 46 in a sensor cover 47. At least a part of components of the joystick 24, e.g. the articulating link 37, the shaft 39, and/or the swashplate 38 may be enclosed by a cover 36.

Springs 44 bias the push rod 40 towards the swashplate 38. As known, as the operator 22 manipulates the joystick 24, the swashplate 38 will move the push rods 40 and the Hall effect sensors 46 will provide (electric) control signals to an associated control for a tool, e.g. the shovel 28. As mentioned above, should the joystick 24 encounter an obstacle/obstruction (like the pipe 32 in FIG. 1A), the operator 22 would not receive the feedback that would be received in a hydraulic joystick.

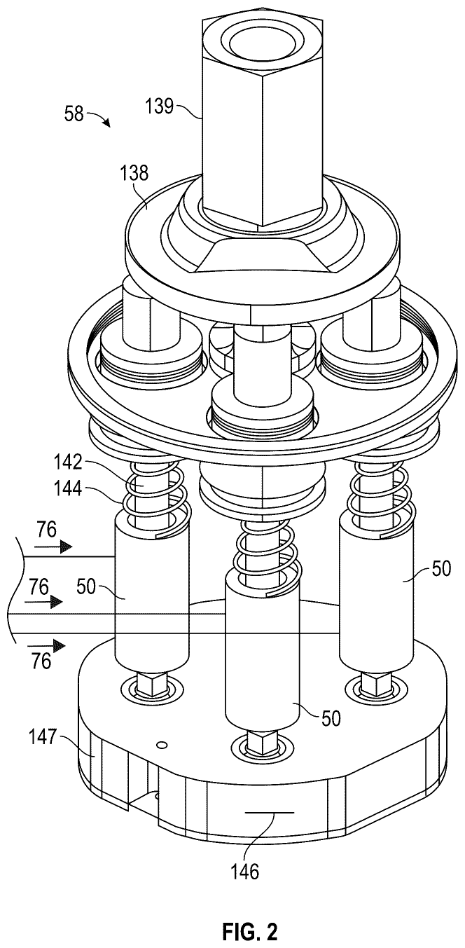

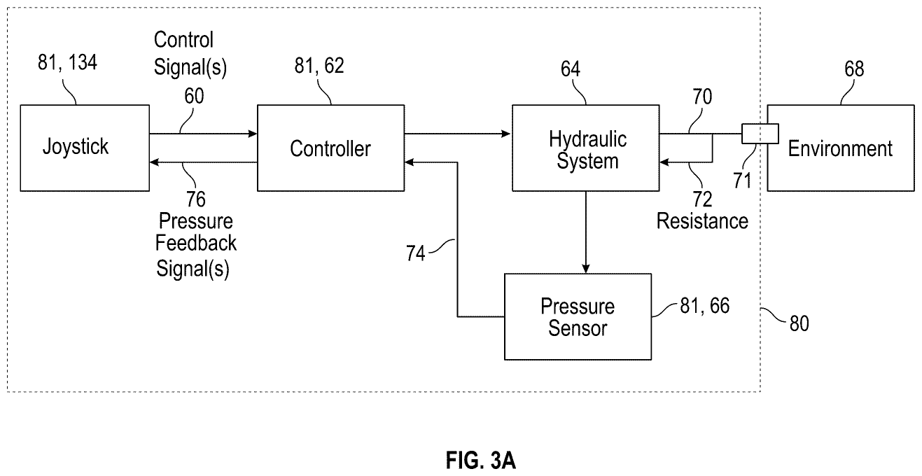

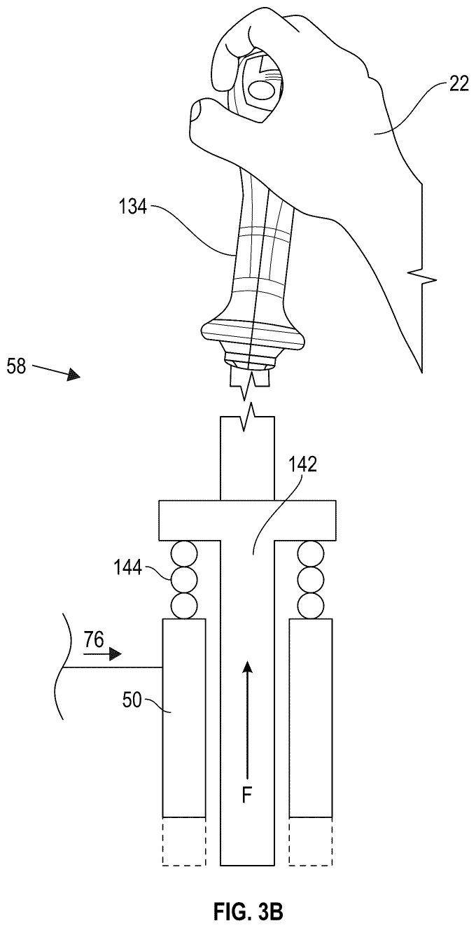

FIG. 2 shows an improved joystick 58. There are still push rods 142 and springs 144 along with a cover 147 housing Hall effect sensors 146, shown schematically. In general, the joystick 58 may comprise a joystick sensor unit for sensing movements of the push rods 142. A swashplate 138 is illustrated along with a shaft 139. Although not shown, a handle, cover and/or link like shown in FIG. 1B may be included. For example, FIG. 3B shows the joystick 58 with a handle 134.

However, in this embodiment, so called “push” solenoid actuators 50 are positioned around each of the push rods 142. For each push rod 142, a corresponding (at least one corresponding) solenoid 50 is provided. A control for the system, for example an electronic controller 62 (see FIG. 3A) communicates with the solenoids 50 such that when an increase in hydraulic pressure is sensed at the tool (e.g. the shovel 28), the solenoid 50 will be actuated to push the push rods 142 back towards the swash plate 138 to provide (mechanical) feedback to the operator 22 that there is the potential of having contacted an obstruction, such as the pipe 32 in FIG. 1A.

An overall assembly 80 is illustrated in FIG. 3A. The assembly 80 includes the joystick 58, a controller 62, a hydraulic system 64, and a pressure sensor 66. A tool 71 is actuatable/movable by means of the hydraulic system 64. The controller 62 and/or the pressure sensor 66 may be considered forming part of the hydraulic system 64. The hydraulic system 64 provides electrohydraulic work functions. The hydraulic system 64 has a hydraulic tool drive 70 controlling movement of a tool 71, e.g. for performing work on an environment 68.

The overall system 80 may be implemented, for example, in a vehicle, e.g. in the vehicle 20 as shown in FIG. 1.

The assembly 80 may be configured for mechanical coupling with the tool 71 (e.g. if the tool 71 is the shovel 28 as shown in FIG. 1A, wherein the shovel 28 can be detachable from the arm 21 of the vehicle 20).

Naturally, the assembly 80 can include the tool 71 in some embodiments. The tool 71 itself may include the hydraulic tool drive 70 or parts of the hydraulic tool drive 70.

The pressure sensor 66 senses hydraulic pressure at the hydraulic system 64, e.g. at the hydraulic tool drive 70. Resistance feedback 72 from the tool 71 will provide a pressure increase should the tool 71 encounter an obstacle/obstruction, for example such as the pipe 32 shown in FIG. 1A.

The pressure sensor 66 will sense this increase and communicate back to the controller 62 through a communication line 74.

The controller 62 can be an electronic controller. The controller 62 receives control signals 60 from the Hall effect sensors 146 on the joystick 58. However, the controller 62 also sends pressure feedback signals 76 back to the joystick 58. This pressure feedback signals 76 are indicative of the pressure increase sensed with the pressure sensor 66. The pressure feedback signals 76 will actuate the push solenoids 50. Naturally, the system can provide several pressure sensors 66 in order to provide selective pressure feedback signals 76 in order to provide selective (mechanical) feedback to the operator 22, e.g. for different axes and/or directions of moving the handle 134, and/or for different types and/or directions of movements of the tool 71.

FIG. 3B schematically shows for one of the push rods 142 how the (mechanical) feedback is applied to the handle 134 and hence provided to the operator 22. As shown schematically at FIG. 3B, one of the push solenoid 50 is provided with the pressure feedback signal 76. A force F is supplied to the corresponding push rod 142 from the push solenoid 50. The operator 22, attempting to manipulate the joystick 58 via the handle 134 will sense that resistance, and the operator 22 will thus be provided with the (mechanical) feedback that the pressure has increased. In other words, the (mechanical) feedback is applied to the handle 134 by means of the push solenoid 50 based on the pressure feedback signal 76.

While Hall effect sensors 146 are illustrated, other types of sensors may be utilized in addition or alternatively. While the swashplate joystick 58 is illustrated, other types of joysticks may also be utilized.

Although embodiments have been disclosed, a worker of skill in this art would recognize that modifications would come within the scope of this invention. For that reason the following claims should be studied to determine the true scope and content.

1. A control system for a hydraulic system for moving a tool, the control system comprising a joystick and an electronic controller,
wherein the joystick includes a joystick handle configured to be manipulated by an operator for indicating desired movements of the tool and joystick sensors for sensing movements of the joystick handle, wherein the joystick is configured for providing control signals to the electronic controller based on the movements of the joystick handle;
wherein the control system is operable to provide feedback to the joystick handle should there be an increase in hydraulic pressure sensed at the hydraulic system related to the tool.

2. The control system as set forth in claim 1, wherein the joystick further includes a swashplate and a plurality of push rods, wherein the joystick handle is configured to move the swashplate for in turn controlling movements of the push rods toward and away from the joystick sensors, wherein the joystick is configured to sense movements of each of the push rods, and to create the control signals to the electronic controller thereupon.

3. The control system according to claim 2, wherein the joystick includes, for each of the push rods, a respective spring for biasing the corresponding push rod towards the swashplate.

4. The control system according to claim 2, wherein each of the push rods is surrounded by a corresponding solenoid, and wherein the electronic controller is configured to control each of the solenoids to provide a pushing magnetic force on the corresponding push rod to urge it towards the swashplate.

5. The control system according to claim 2, wherein the joystick sensors are Hall effect sensors.

6. The control system according to claim 1, wherein the joystick sensors are Hall effect sensors.

7. An assembly for operating a tool, wherein the assembly comprises:
a hydraulic system having a hydraulic tool drive for moving the tool; and
a control system including a joystick and an electronic controller,
wherein the joystick includes a joystick handle configured to be manipulated by an operator for indicating desired movements of the tool and joystick sensors for sensing movements of the joystick handle, wherein the joystick is configured for providing control signals to the electronic controller based on the movements of the joystick handle;
wherein the control system is operable to provide feedback to the joystick handle should there be an increase in hydraulic pressure sensed at the hydraulic system related to the tool.

8. The assembly according to claim 7, wherein the electronic controller communicating with the joystick, the joystick being adapted to be manipulated and the joystick sensors sending the control signals to the electronic controller to supply the hydraulic fluid to the tool drive for moving the tool, and the electronic controller being operable to provide a pressure feedback signal to the joystick to provide a feedback force should the sensed hydraulic pressure increase.

9. The assembly according to claim 8, wherein the assembly further includes the tool, wherein the tool is a shovel and the assembly is configured such that the hydraulic pressure increases when the shovel encounters an obstruction.

10. The assembly according to claim 7, wherein the tool is a shovel and the assembly is configured such that the hydraulic pressure increases when the shovel encounters an obstruction.

11. The control system as set forth in claim 7, wherein the joystick further includes a swashplate and a plurality of push rods, wherein the joystick handle is configured to move the swashplate for in turn controlling movements of the push rods toward and away from the joystick sensors, wherein the joystick is configured to sense movements of each of the push rods, and to create the control signals to the electronic controller thereupon.

12. The control system according to claim 11, wherein the joystick includes, for each of the push rods, a respective spring for biasing the corresponding push rod towards the swashplate.

13. The control system according to claim 11, wherein each of the push rods is surrounded by a corresponding solenoid, and wherein the electronic controller is configured to control each of the solenoids to provide a pushing magnetic force on the corresponding push rod to urge it towards the swashplate.

14. The control system according to claim 7, wherein the joystick sensors are Hall effect sensors.

15. A method comprising:
providing a tool and a control system for controlling movement of the tool, the control system including an electronic controller and a joystick connected to the electronic controller,
the joystick sending control signals to the electronic controller,
the electronic controller controlling supply of hydraulic fluid to a hydraulic tool drive to move the tool based upon the control signals from the joystick, a pressure sensor sensing a hydraulic pressure at the hydraulic tool drive as the tool moves; and
the electronic controller providing a pressure feedback signal to the joystick to provide a feedback force based upon the sensed hydraulic pressure.

16. The method according to claim 15, wherein, in the joystick, a joystick handle moves a swashplate to move a plurality of push rods toward and away from a joystick sensor unit sensing movement of each of the plurality of push rods, wherein the joystick sensor unit sends the control signals to the electronic controller.

17. The method according to claim 16, wherein the joystick sensor unit includes Hall effect sensors.

18. The method according to claim 17, wherein each of the push rods is pressed towards the swashplate by a respective biasing spring.

19. The method according to claim 16, wherein each of the push rods is surrounded by a corresponding solenoid, and wherein the electronic controller controls at least one of the solenoids to provide a magnetic force on the corresponding push rod to urge it towards the swashplate based on an increase of the sensed hydraulic pressure.

20. The method according to claim 15, wherein the tool is a shovel and the hydraulic fluid increases in hydraulic pressure as the shovel encounters an obstruction.
